(19) United States
(12) Patent Application Publication
(10) Pub. No.: US 2025/0103941 A1
(43) Pub. Date: Mar. 27, 2025

(54) QUANTUM COMPILATION DEVICE, QUANTUM COMPILATION METHOD, AND PROGRAM

(71) Applicant: NIPPON TELEGRAPH AND TELEPHONE CORPORATION, Tokyo (JP)

(72) Inventors: Seiseki AKIBUE, Tokyo (JP); Go KATO, Tokyo (JP); Seiichiro TANI, Tokyo (JP)

(73) Assignee: NIPPON TELEGRAPH AND TELEPHONE CORPORATION, Tokyo (JP)

(21) Appl. No.: 18/832,681

(22) PCT Filed: Feb. 1, 2022
(86) PCT No.: PCT/JP2022/003865

§ 371 Date: Jul. 24, 2024

(51) Int. Cl. G06N 10/80; G06N 10/20

(52) U.S. Cl. CPC G06N 10/80; G06N 10/20

(57) ABSTRACT

A quantum compilation device obtains a probability p(k) that minimizes an error between a distribution of first observed values obtained by observing, with any observation method, a first quantum state obtained by causing the quantum circuit to be compiled represented by a unitary matrix U to act on any input quantum state, and a distribution of second observed values obtained by observing, with the observation method, a second quantum state obtained by causing a quantum circuit represented by each of a plurality of elements Uₖ∈{U₁, . . . , U_{K}} of a set {U₁, . . . , U_{K}} to act on the input quantum state with the probability p(k), for the set {U₁, . . . , U_{K}} in which a unitary matrix representing elementary gates and/or a unitary matrix representing a product of unitary matrices each representing an elementary gate are the elements U₁, . . . , and U_{K}, and the unitary matrix U representing a quantum circuit to be compiled, and outputs an element Uₖ with the probability p(k). Here, K is an integer of 2 or more, and k=1, . . . , and K.

### TECHNICAL FIELD

The present invention relates to a technique for compiling a quantum circuit.

### BACKGROUND ART

Many quantum circuits are composed of small-scale quantum circuits on constant quantum bits. Furthermore, many methods for decomposing (compiling) these small-scale quantum circuits into a plurality of elementary gates (elementary gate elements) have been proposed. Here, the operation of the quantum circuit or the elementary gate can be expressed in a form of a unitary matrix acting on a complex vector representing an input quantum state. Hereinafter, a unitary matrix expressing the operation of the quantum circuit is referred to as a unitary matrix representing the quantum circuit, and a unitary matrix expressing the operation of the elementary gate is referred to as a unitary matrix representing the elementary gate.

Non Patent Literature 1 discloses a quantum compiling method in which a unitary matrix representing any quantum circuit is approximated by a finite number of unitary matrices or a product of unitary matrices. A unitary matrix and a product of unitary matrices represent an elementary gate and a combination of a plurality of elementary gates, respectively. Hereinafter, the combination of the elementary gate and/or the plurality of elementary gates is collectively referred to as an elementary gate sequence.

### CITATION LIST

### Non Patent Literature

Non Patent Literature 1: Aram W. Harrow, Benjamin Recht, Isaac L. Chuang, “Efficient Discrete Approximations of Quantum Gates”, Journal of Mathematical Physics 43, 4445 (2002)

### SUMMARY OF INVENTION

### Technical Problem

The compiling method of Non Patent Literature 1 deterministically searches for one elementary gate sequence that most accurately realizes the quantum circuit to be compiled from a plurality of elementary gate sequence possibilities. This approximation accuracy increases as the number of possibilities of the elementary gate sequence increases, and the number of possibilities of the elementary gate sequence increases as the number of elementary gates combined in the elementary gate sequence increases. In other words, the longer the length of the elementary gate sequence, the higher the approximation accuracy. On the other hand, from the viewpoint of compiling efficiency, it is preferable that the elementary gate sequence is short, that is, a small number of elementary gates is used.

The present invention has been made in view of such a point, and an object thereof is to provide a quantum compilation technique capable of improving approximation accuracy without increasing the length of an elementary gate sequence.

### Solution to Problem

A quantum compilation device obtains a probability p(k) that minimizes an error between a distribution of first observed values obtained by observing, with any observation method, a first quantum state obtained by causing the quantum circuit to be compiled represented by a unitary matrix U to act on any input quantum state, and a distribution of second observed values obtained by observing, with the observation method, a second quantum state obtained by causing a quantum circuit represented by each of a plurality of elements Uₖ∈{U₁, . . . , U_{K}} of a set {U₁, . . . , U_{K}} to act on the input quantum state with the probability p(k), for the set {U₁, . . . , U_{K}} in which a unitary matrix representing elementary gates and/or a unitary matrix representing a product of unitary matrices each representing an elementary gate are the elements U₁, . . . , and U_{K}, and the unitary matrix U representing a quantum circuit to be compiled, and outputs an element Uₖ with the probability p(k). Here, K is an integer of 2 or more, and k=1, . . . , and K.

### Advantageous Effects of Invention

In the present invention, since the quantum circuit can be stochastically compiled into the elementary gate sequence, the approximation accuracy can be improved without increasing the length of the elementary gate sequence.

### BRIEF DESCRIPTION OF DRAWINGS

FIG. 1 is a block diagram illustrating a configuration of a quantum compilation system according to an embodiment.

FIG. 2 is a block diagram illustrating a configuration of a quantum compilation device according to the embodiment.

FIG. 3 is a diagram for describing an effect according to the embodiment.

FIG. 4 is a diagram for describing an application example of quantum compilation according to the embodiment.

FIG. 5 is a block diagram for illustrating a hardware configuration according to the embodiment.

### DESCRIPTION OF EMBODIMENTS

Next, an embodiment of the present invention will be described.

### Overview

First, the overview of the embodiment is described.

In the present embodiment, the quantum circuit to be compiled is stochastically decomposed into elementary gate sequences. Details will be described below.

In a quantum compilation device according to the embodiment, a set {U₁, . . . , U_{K}} (that is, each of elements U₁, . . . , and U_{K} represents a unitary matrix representing an elementary gate sequence) in which a unitary matrix representing elementary gates and/or a unitary matrix representing a product of unitary matrices each representing an elementary gate are the elements U₁, . . . , and U_{K}, and the unitary matrix U representing a quantum circuit to be compiled are input. The quantum compilation device, using these, obtains a probability p(k) that minimizes an error between a distribution of first observed values obtained by observing, with any observation method, a first quantum state obtained by causing the quantum circuit to be compiled represented by a unitary matrix U to act on any input quantum state, and a distribution of second observed values obtained by observing, with the observation method, a second quantum state obtained by causing a quantum circuit represented by each of a plurality of elements Uₖ∈{U₁, . . . , U_{K}} of a set {U₁, . . . , U_{K}} to act on the input quantum state with the probability p(k). Here, k=1, . . . , and K, and K is an integer of 2 or more. The quantum compilation device obtains probabilities p(k) for a plurality of k. The quantum compilation device may obtain the probability p(k) for all k=1, . . . , and K, or may obtain the probability p(k) for some k=1, . . . , and K. The quantum compilation device outputs an element U_{K}∈{U₁, . . . , U_{K}} with the probability p(k). For example, the quantum compilation device selects one element Uₖ from the set {U₁, . . . , U_{K}} and outputs the selected element Uₖ. A probability that the element Uₖ is selected is p(k). Alternatively, the quantum compilation device may select a plurality of elements Uₖ from the set {U₁, . . . , U_{K}} and may output the selected elements Uₖ. The probability that each element Uₖ is selected is p(k). In this manner, the output element Uₖ is the compiling result of the unitary matrix U representing the quantum circuit to be compiled. That is, the unitary matrix U representing the quantum circuit to be compiled is approximated by the output element Uₖ.

As a result, the approximation accuracy of the unitary matrix U representing the quantum circuit to be compiled can be improved without increasing the length of the elementary gate sequence. That is, in the case of compiling with any one element U_{k′}∈{U₁, . . . , U_{K}} deterministically selected from the set {U₁, . . . , U_{K}} (for example, Non Patent Literature 1), it is assumed that the unitary matrix U can be approximated with the approximation accuracy E=ε by the set {U₁, . . . , U_{K}}. Here, k′∈{1, . . . , K}, and 0≤ε≤1. In this case, by compiling with the element Uₖ stochastically selected with the probability p(k) from the set {U₁, . . . , U_{K}}, the unitary matrix U can be approximated with the approximation accuracy E=ε² or substantially E=ε² by the set {U₁, . . . , U_{K}}. Here, the smaller E is, the higher the approximation accuracy is. Therefore, in a case where the elementary gate having the same length as the conventional elementary gate is used, higher approximation accuracy than the conventional elementary gate can be realized. In addition, the same approximation accuracy as in the related art can be realized by the elementary gate sequence having a shorter length than in the related art. Note that the case where the unitary matrix U can be approximated by the set {U₁, . . . , U_{K}} with the approximation accuracy E means that the distribution {P(x)} of the observed value x obtained by observing, with any observation method, the quantum state obtained by causing the quantum circuit to be compiled represented by the unitary matrix U to act on any input quantum state, and the distribution {Q(x)} of the observed value x obtained by observing, with any observation method, the quantum state obtained by causing the quantum circuit represented by an appropriate element Uₖ∈{U₁, . . . , U_{K}} belonging to the set {U₁, . . . , U_{K}} to act on any input quantum state deviate only by E at most in the sense of total variation. For example, this means that Σₓ(½)|P(x)−Q(x)|≤E is satisfied.

The quantum compilation device uses, for example, a set {U₁, . . . , U_{K}} and a unitary matrix U to obtain p^{→}={p(1), . . . , p(k)}∈Δ that achieves the following expression.

$${min}_{\vec{p} ∈ Δ} {max}_{\vec{x} ∈ R} {\vec{x}}^{T} ( \vec{b} - A \vec{p} ) \qquad [ Math . 1 ]$$

That is, the quantum compilation device obtains, for example, p^{→}={p(1), . . . , p(k)}∈Δ that minimizes under x^{→}∈R that maximizes

$${\vec{x}}^{T} ( \vec{b} - A \vec{p} ) , \qquad [ Math . 2 ]$$

and sets the element of p^{→} to the probability p(1), . . . , p(k) described above. Here, the unitary matrix U to be compiled is a 2^{N}×2^{N} matrix, N is an integer of 1 or more, e_{L}^{→} represents a 2^{N}-dimensional vertical vector, the L-th element from the head of the vertical vector e_{L}^{→} is 1, the other 2^{N}-1 elements are 0, and L=1, . . . , 2^{N},

$$\vec{U} = {\sum }_{L = 1}^{{2}^{N}} \vec{{e}_{L}} ⊗ ( U \vec{{e}_{L}} ) , \qquad [ Math . 3 ]$$

$$\vec{{U}_{k}} = {\sum }_{L = 1}^{{2}^{N}} \vec{{e}_{L}} ⊗ ( {U}_{k} \vec{{e}_{L}} ) , \qquad [ Math . 4 ]$$

$$and$$

$${α}_{1} ⊗ {α}_{2} \qquad [ Math . 5 ]$$

represent a Kronecker product of α₁ and α₂, the unitary matrix Uₖ is a 2^{N}×2^{N} matrix, and U^{→} and Uₖ^{→} are 2^{2N}-dimensional vertical vectors. In addition, A represents a real matrix, a k-th column vector from a head of the real matrix A is ((Uₖ^{→})⁺σ₁Uₖ^{→}, (Uₖ^{→})⁺σ₂Uₖ^{→}, (Uₖ^{→})⁺σ_{J}Uₖ^{→})^{T}, {σ₁, . . . , σ_{J}} is the orthonormal basis of a 2^{2N}×2^{2N} Hermitian matrix, J=2^{4N}, j=1, . . . , J, β⁺ represents an adjoint matrix of β, and γ^{T} represents transposition of γ, b^{→} represents a real vector, and b^{→}=((U^{→})⁺σ₁U^{→}, (U^{→})⁺σ₂U^{→}, . . . , (U^{→})⁺σ_{J}U^{→})^{T}, Δ represents a set of real vectors, and Δ={(p(1), p(2), . . . , p(k))^{T}|Σₖ₌₁, . . . , ₖp(k)=1, p(k)≥0}, R represents a set of real vectors, and R={(tr[σ₁Φ], tr[σ₂Φ], . . . , tr[σ_{J}Φ])^{T}:^{∃}ρ≥0, (tr [ρ]=1)∧(0≤Φ≤ρ(×)I)}, tr[κ] represents a trace of κ, I represents a unit matrix of 2^{N}×2^{N}, ρ represents a positive semi-definite matrix of 2^{N}×2^{N}, γ≥0 and 0≤γ in the matrix γ represent that γ is a positive semi-definite matrix, that is, a Hermitian matrix of which an eigenvalue is non-negative, γ₁≤γ₂ in the matrices γ₁ and γ₂ of η×η represents that γ₂−γ₂≥0, that is, γ₂−γ₂ is a positive semi-definite matrix, η is an integer of 1 or more, μ is an integer of 1 or more, and Φ represents a positive semi-definite matrix of 2^{2N}×2^{2N}. In addition, the superscript “→” of x^{→} should be added directly above “x”, but it may be added to the upper right of “x” due to restriction of description. The same applies to e_{L}^{→}, U^{→}, b^{→}, p^{→}, and Uₖ^{→}. However, this is merely an example, and the quantum compilation device may obtain the probability p(k) by using the set {U₁, . . . , U_{K}} and the unitary matrix U with other methods.

### Embodiment

Hereinafter, the present embodiment will be described with reference to the drawings.

### Configuration

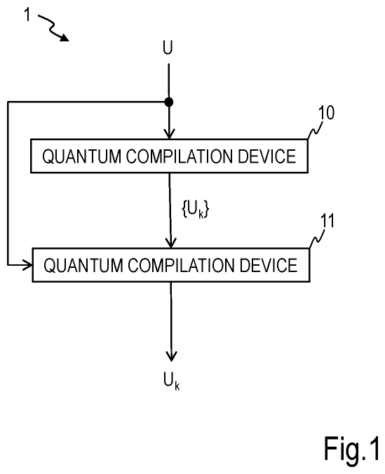

As illustrated in FIG. 1, a quantum compilation system 1 of the present embodiment includes a quantum compilation device 10 and a quantum compilation device 11. The quantum compilation devices 10 and 11 are, for example, devices configured by reading a predetermined program in a known computer. The quantum compilation device 10 and the quantum compilation device 11 may be configured integrally or separately.

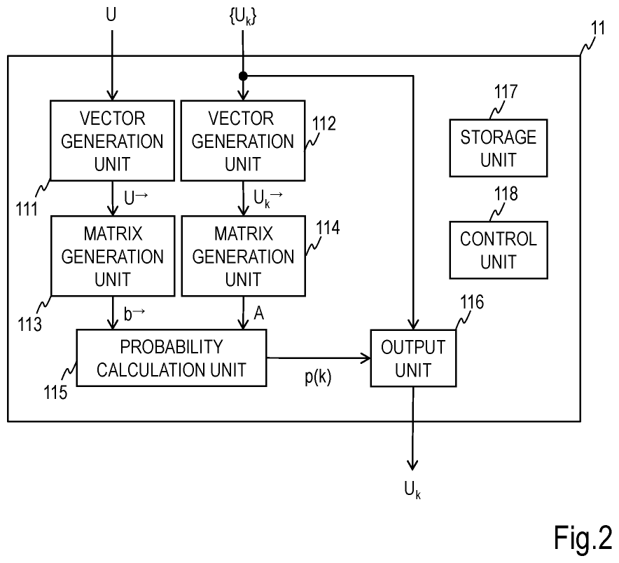

As illustrated in FIG. 2, the quantum compilation device 11 of the present embodiment includes vector generation units 111 and 112, matrix generation units 113 and 114, a probability calculation unit 115, an output unit 116, a storage unit 117, and a control unit 118. Although not described below, the quantum compilation device 11 executes each processing under the control of the control unit 118, and the input information and the information obtained by each processing are stored in the storage unit 117. The information stored in the storage unit 117 is read and used as necessary, and is used for each processing.

### Processing

Hereinafter, processing of the present embodiment will be exemplified.

### Processing of Quantum Compilation Device 10

As illustrated in FIG. 1, a unitary matrix U representing a quantum circuit to be compiled is input to the quantum compilation device 10. However, the unitary matrix U is a 2^{N}×2^{N} matrix. N represents the number of quantum bits on which the quantum circuit represented by the unitary matrix U acts. N is an integer constant of 1 or more. The quantum compilation device 10 obtains and outputs a set {U₁, . . . , U_{K}} that can approximate the unitary matrix U with the approximation accuracy E=ε. Although the processing content is not limited, for example, the quantum compilation device 10 obtains and outputs a set {U₁, . . . . U_{K}} by the method described in Non Patent Literature 1. According to Non Patent Literature 1, it is known that a 2^{N}×2^{N} unitary matrix U representing any quantum circuit on a constant quantum bit can be approximated with any accuracy using a set {gᵢ} of finite unitary matrices representing a set of elementary gates (universal gate set). Further, it is also known that the 2^{N}×2^{N} unitary matrix U can be sufficiently approximated with approximation accuracy E by the set {gᵢ} of unitary matrices of length of the following expression.

$$[ Math . 6 ]$$

$$K = 0 ( {log}^{b} \frac{1}{E} ) \qquad ( 1 a )$$

Note that b is a real number of 1 or more, and the base of the logarithm is, for example, 2. The processing in this case is as follows.

Step S101: The quantum compilation device 10 sets M=1.

Step S102: The quantum compilation device 10 obtains a set {U₁, . . . , U_{K}} of unitary matrices U₁, . . . , and U_{K} each representing a quantum circuit that can be mounted on M or less elementary gates. That is, each element Uₖ of a set {U₁, . . . , U_{K}} is a product of one 2^{N}×2^{N} unitary matrix or M or less unitary matrices. Each element Uₖ is a 2^{N}×2^{N} unitary matrix. For example, in a case where the type of the elementary gate to be used is three types of an Hadamard transform gate, a π/2 phase shift gate, and a π/4 phase shift gate, the unitary matrix g₁ representing the Hadamard transform gate is H, the unitary matrix g₂ representing the π/2 phase shift gate is S, the unitary matrix g₃ representing the π/4 phase shift gate is T, the unit matrix (unitary matrix) representing that the gate is not caused to act is I, and M=1, {U₁, U₂, U₃, U₄}={I, g₁, g₂, g₃}={I, H, S, T} is obtained (U₁=I, U₂=H, U₃=S, U₄=T). However, the following conditions are satisfied.

$$I = ( \begin{matrix}1 & 0 \\ 0 & 1\end{matrix} ) \qquad [ Math . 7 ]$$

$$S = ( \begin{matrix}1 & 0 \\ 0 & i\end{matrix} ) \qquad [ Math . 8 ]$$

$$H = \frac{1}{\sqrt{2}} ( \begin{matrix}1 & 1 \\ 1 & - 1\end{matrix} ) \qquad [ Math . 9 ]$$

$$T = ( \begin{matrix}1 & 0 \\ 0 & {e}^{i \frac{π}{4}}\end{matrix} ) \qquad [ Math . 10 ]$$

Here, i represents an imaginary unit. When the same elementary gate is used and M=2, the set {U₁, . . . , U₁₀}={I, g₁, g₂, . . . , (g₁g₁), (g₁g₂), . . . , (g₃g₃)}={I, H, S, T, HS, HT, SH, SS, ST, TH} is obtained (U₁=I, U₂=H, U₃=S, U₄=T, U₅=HS, U₆=HT, U₇=SH, U₈=SS, U₉=ST, U₁₀=TH). Note that overlapping elements such as I=HH, S=TT, and ST=TS are removed from the set of unitary matrices. In this example, the set of unitary matrices {U₁, . . . , U_{K}} can be generalized as {U₁, . . . , U_{K}}={I, g₁, g₂, . . . , (g₁g₁), (g₁g₂), . . . , (g₁g₁g₁), (g₁g₁g₂), . . . }.

Step S103: The quantum compilation device 10 determines whether or not the input unitary matrix U can be approximated by a set {U₁, . . . , U_{K}} with an approximation accuracy E=ε. This determination may be performed using the method described in Non Patent Literature 1, or may be performed using other methods. For example, in a case where Σₓ(½)|P(x)−Q(x)|≤ε is satisfied for any unitary matrix U, the quantum compilation device 10 determines that any unitary matrix U can be approximated by a set {U₁, . . . , U_{K}} with the approximation accuracy E=ε, and otherwise, determines that approximation cannot be performed. Here, when it is determined that approximation can be performed with the approximation accuracy E=ε, the quantum compilation device 10 outputs a set {U₁, . . . , U_{K}}. On the other hand, when it is determined that approximation cannot be performed with the approximation accuracy E=ε, the quantum compilation device 10 sets M+1 as new M (increases M by one) and returns the processing to step S102.

Processing of Quantum Compilation Device 11 The 2^{N}×2^{N} unitary matrix U representing the quantum circuit to be compiled and the set {U₁, . . . , U_{K}} output from the quantum compilation device 10 in step S103 are input to the quantum compilation device 11 (FIG. 2). That is, the quantum compilation device 11 receives the set {U₁, . . . , U_{K}} in which a unitary matrix representing elementary gates and/or a unitary matrix representing a product of unitary matrices each representing an elementary gate are the elements U₁, . . . , and U_{K}, and a unitary matrix U representing a quantum circuit to be compiled.

The unitary matrix U is input to the vector generation unit 111 of the quantum compilation device 11, and the set {U₁, . . . , U_{K}} is input to the vector generation unit 112. The vector generation unit 111 uses the unitary matrix U to obtain and output a vector

$$\vec{U} = {\sum }_{L = 1}^{{2}^{N}} \vec{{e}_{L}} ⊗ ( U \vec{{e}_{L}} ) \qquad [ Math . 11 ]$$

(step S111). The vector generation unit 112 uses the set {U₁, . . . , U_{K}} to obtain and output a vector

$$\vec{{U}_{k}} = {\sum }_{L = 1}^{{2}^{N}} \vec{{e}_{L}} ⊗ ( {U}_{k} \vec{{e}_{L}} ) \qquad [ Math . 12 ]$$

for k=1, . . . , and K. Here, U^{→} and Uₖ^{→} are 2^{2N}-dimensional vertical vectors, and e_{L}^{→} represents a 2^{N}-dimensional vertical vector. The L-th element from the head of the vertical vector e_{L}^{→} is 1, and the other 2^{N}-1 elements are 0. L=1, . . . , 2^{N} (step S112).

The vector U^{→} obtained in step S111 is input to the matrix generation unit 113, and the vector Uₖ^{→} obtained in step S112 is input to the matrix generation unit 114. The matrix generation unit 113 uses the vector U^{→} to obtain and output the real vector b^{→}=((U^{→})⁺σ₁U^{→}, (U^{→})⁺σ₂U^{→}, . . . , (U^{→})⁺σ_{J}U^{→})^{T} (step S113). The matrix generation unit 114 uses the vector Uₖ^{→} to obtain and output the real matrix A. However, the k-th column vector from the head of the real matrix A is ((Uₖ^{→})⁺σ₁Uₖ^{→}, (Uₖ^{→})⁺σ₂Uₖ^{→}, (Uₖ^{→})⁺σ_{J}Uₖ^{→})^{T}, β⁺ represents an adjoint matrix of β, and γ^{T} represents transposition of γ. Note that {σ₁, . . . , σ_{J}} is an orthonormal basis of a 2^{2N}×2^{2N} Hermitian matrix, J=2^{4N}, and j=1, . . . , and J. Here, a set of Hermitian matrices is regarded as an inner product space under the Hilbert-Schmidt inner product. The orthonormal basis {σ₁, . . . , σ_{J}} may be set in advance or may be generated by a processing unit (not illustrated) (step S114).

The real vector b-obtained in step S113 and the real matrix A obtained in step S114 are input to the probability calculation unit 115. The probability calculation unit 115 obtains and outputs p^{→}={p(1), . . . , p(k)}∈Δ that achieves the following expression.

$${min}_{\vec{p} ∈ Δ} {max}_{\vec{x} ∈ R} {\vec{x}}^{T} ( \vec{b} - A \vec{p} ) \qquad [ Math . 13 ]$$

$$α = {min}_{\vec{p} ∈ Δ} {max}_{\vec{x} ∈ R} {\vec{x}}^{T} ( \vec{b} - A \vec{p} ) \qquad [ Math . 14 ]$$

In other words, when the above expression is satisfied, the probability calculation unit 115 sets the element of p^{→}∈Δ to the probability p(1), . . . , p(k) described above to achieve the following expression.

$${max}_{\vec{x} ∈ R} {\vec{x}}^{T} ( \vec{b} - A \vec{p} ) = α \qquad [ Math . 15 ]$$

Here, A represents a set of real vectors Δ={(p(1), p(2), . . . , p(k))^{T}|Σₖ₌₁, . . . , _{K}p(k)=1, p(k)≥0}, and R represents a set of real vectors R={(tr[σ₁Φ], tr[σ₂Φ], . . . , tr[σ_{J}Φ])^{T}:^{∃}ρ≥0, (tr [ρ]=1)∧(0≤Φ≤ρ(×)I)}. tr[κ] represents a trace of κ, I represents a 2^{N} ×2^{N} unit matrix, and p represents a 2^{N}×2^{N} positive semi-definite matrix. γ≥0 and 0≤γ in the matrix γ represent that γ is a positive semi-definite matrix, that is, a Hermitian matrix having a non-negative eigenvalue, and γ₁≤γ₂ in the matrices γ₁ and γ₂ of η×η represents that γ₂−γ₁≥0, that is, γ₂−γ₁ is a positive semi-definite matrix. Here, η is an integer of 1 or more, and μ is an integer of 1 or more. Φ represents a 2^{2N}×2^{2N} positive semi-definite matrix. The probability calculation unit 115 can obtain p^{→} using, for example, a known minimax optimization algorithm. For example, since Δ and R are compact (bounded closed set) and convex sets, the probability calculation unit 115 can obtain p-using, for example, the low regret learning algorithm or the like (step S115).

The probabilities p(1), . . . , p(k) obtained in step S115 and the set {U₁, . . . , U_{K}} output from the quantum compilation device 10 in step S103 are input to the output unit 116. The output unit 116 selects and outputs the element Uₖ with the probability p(k) (step S115).

### Reason Why Approximation Accuracy of Unitary Matrix U Representing Quantum Circuit to Be Compiled Can Be Improved Without Increasing Number of Types of Elementary Gates

As described above, the quantum compilation device 11 uses, for example, a set {U₁, . . . , U_{K}} and a unitary matrix U, to obtain p^{→}={p(1), . . . , p(k)}∈Δ that achieves the following expression.

$$[ Math . 16 ]$$

$${min}_{\vec{p} ∈ Δ} {max}_{\vec{x} ∈ R} {\vec{x}}^{T} ( \vec{b} - A \vec{p} ) \qquad ( 1 )$$

Here, a combination (ρ, Π, ν) of the input quantum state ρ, the measurement Π, and the subset ν of the measured values is represented by a real vector, and x^{→}∈R, and the range R of x^{→} corresponds to all combinations of (ρ, Π, ν). Further,

$${\vec{x}}^{T} ( \vec{b} - A \vec{p} ) \qquad [ Math . 17 ]$$

represents Σ_{x∈ν}(P(x)−Q(x)). Here, {P(x)}_{x∈Θ} represents a distribution of measured values obtained by measuring a quantum state obtained by causing the quantum circuit represented by the unitary matrix U to act on the input quantum state ρ by the measurement method of the measurement Π, and {Q(x)}_{x∈Θ} represents a distribution of measured values obtained by measuring a quantum state obtained by causing the quantum circuit represented by the unitary matrix Uₖ to act on the input quantum state ρ with the probability p(k) by the measurement method of the measurement Π. Θ represents an overall set of measured values (ν⊆Θ). Accordingly,

$$\begin{matrix}{max}_{\vec{x} ∈ R} {\vec{x}}^{T} ( \vec{b} - A \vec{p} ) = {max}_{ρ , 11 , v} {\sum }_{x ∈ v} ( P ( x ) - Q ( x ) ) \\ = {max}_{ρ , 11} {\sum }_{x ∈ Θ} \frac{1}{2} \vert P ( x ) - Q ( x ) \vert\end{matrix} \qquad [ Math . 18 ]$$

is established. This last modification formula expresses the approximation accuracy (in the sense of total variation) that can achieve the action represented by the unitary matrix U by causing the unitary matrix Uₖ to act with the probability p(k). That is, p^{→}={p(1), . . . , p(k)} that achieves Formula (1) is nothing less than the probability distribution {p(k)} in which the accuracy is the highest when the action of the unitary matrix U is approximated by causing the unitary matrix Uₖ to act with the probability p(k).

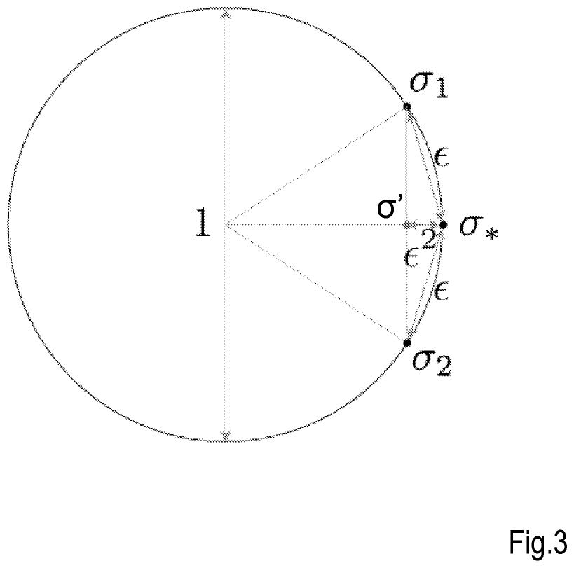

In addition, the reason why the approximation accuracy is E=ε² or substantially E=ε² by the method of the present embodiment is as follows. The quantum state of one quantum bit can be represented by a surface and an internal point of a three-dimensional sphere having a diameter of 1, and the distance between two points representing two quantum states corresponds to the maximum value of total variation of the measurement distribution of the two quantum states. Here, it is assumed that a unitary matrix U representing a quantum circuit acting on any one quantum bit can be approximated by a set {U₁, . . . , U_{K}} with an approximation accuracy E=ε. In this case, the quantum state σ* obtained by causing the quantum circuit represented by the unitary matrix U to act on the input quantum state ρ of one quantum bit and the quantum state σₖ obtained by causing the quantum circuit represented by the unitary matrix Uₖ to act on the input quantum state ρ can be regarded as being separated by the distance ε on the three-dimensional sphere. FIG. 3 illustrates an example of a positional relationship between σ* and σₖ. However, in FIG. 3, a case where k is 3 or more is omitted for simplification of description. In the example of FIG. 3, the quantum state obtained by causing the quantum circuit represented by U₁ and the quantum circuit represented by U₂ with the probability p(k)= 1/2 to act on the input quantum state ρ corresponds to the midpoint σ′ between σ₁ and σ₂. In this case, the distance between σ* and σ′ is ε². The distance in the three-dimensional sphere represents the maximum value itself of the total variation of the measurement distribution of the corresponding quantum state. Therefore, the unitary matrix U can be approximated with the approximation accuracy E=ε² by causing the quantum circuit represented by U₁ and the quantum circuit represented by U₂ to act with the probability p(k)=½. The same applies to the other quantum state σₖ and probability p(k).

### Features of Embodiment

As described above, in the present embodiment, by stochastically outputting the elementary gate sequence, any quantum circuit can be approximated with the approximation accuracy E=ε². That is, the distribution {P(x)} of the observed value x obtained by observing, with any observation method, the quantum state obtained by causing the quantum circuit to be compiled represented by the unitary matrix U to act on any input quantum state, and the distribution {Q(x)} of the observed value x obtained by observing, with any observation method, the quantum state obtained by causing the quantum circuit represented by an appropriate element Uₖ∈{U₁, . . . , U_{K}} belonging to the set {U₁, . . . , U_{K}} to act on any input quantum state deviate only by ε² at most in the sense of total variation.

For example, consider a case where a set of unitary matrices representing the elementary gates is {I, H, S, T}. Hereinafter, a relationship between the elementary gate number Y and the approximation accuracy E in a case where compiling is performed according to Non Patent Literature 1 will be described.

TABLE 1

| | Number of elementary gates Y | | | | | |
|---|---|---|---|---|---|---|
| | 2 | 3 | 4 | 5 | 6 | 7 |
| Approximation accuracy E | 0.95 | 0.88 | 0.76 | 0.69 | 0.45 | 0.41 |

According to this, in the conventional compilation, there is approximately the following relationship between the number of elementary gates (the number of types of elementary gates) Y and the approximation accuracy E=ε.

$$Y ≅ 6 {log}_{2}^{0.4} \frac{1}{E} \qquad [ Math . 19 ]$$

Therefore, it can be seen that, in order to realize the approximation accuracy E, in the conventional method, the number of elementary gates required approximately

$$6 {log}_{2}^{0.4} \frac{1}{E} \qquad [ Math . 20 ]$$

is sufficient even with

$$6 {log}_{2}^{0.4} \frac{1}{\sqrt{E}} , \qquad [ Math . 21 ]$$

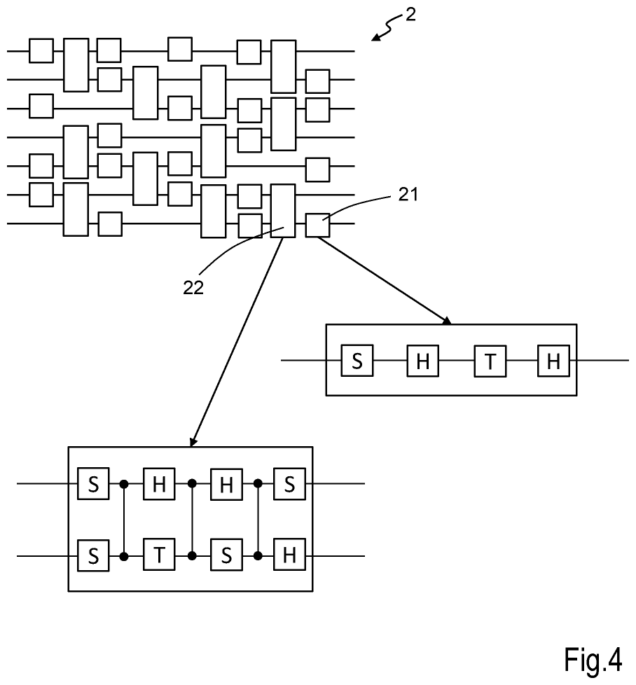

in the present embodiment. This means that the number of types of elementary gates is reduced by approximately 25%. Even in a large-scale quantum circuit 2 illustrated in FIG. 4, the number of types of elementary gates required for realizing each quantum bit circuit 21 and 22 and the like constituting the quantum circuit 2 can be reduced. As a result, the number of types of elementary gates can be significantly reduced as a whole. However, the exponent 0.4 of log represents a tendency when the accuracy is low (E is large), and when the accuracy is high (E is small), the exponent becomes a number of 1 or more as described in Formula (1a), and thus a more significant reduction can be expected.

### Hardware Configuration

The quantum compilation device 11 according to the embodiment is a device formed with a general-purpose or dedicated computer executing a predetermined program, the computer including a processor (hardware processor) such as a central processing unit (CPU), and a memory such as a random access memory (RAM) and a read only memory (ROM), for example. That is, the quantum compilation device 11 in the embodiment includes processing circuitry configured to mount the respective components included in the respective quantum compilation devices. The computer may include one processor and one memory, or may include a plurality of processors and a plurality of memories. The program may be installed into the computer, or may be recorded in a ROM or the like in advance. In addition, some or all of processing units may be configured by using electronic circuitry that independently implements processing functions, instead of electronic circuitry that implements functional components by reading the program such as a CPU. Also, electronic circuitry forming one device may include a plurality of CPUs.

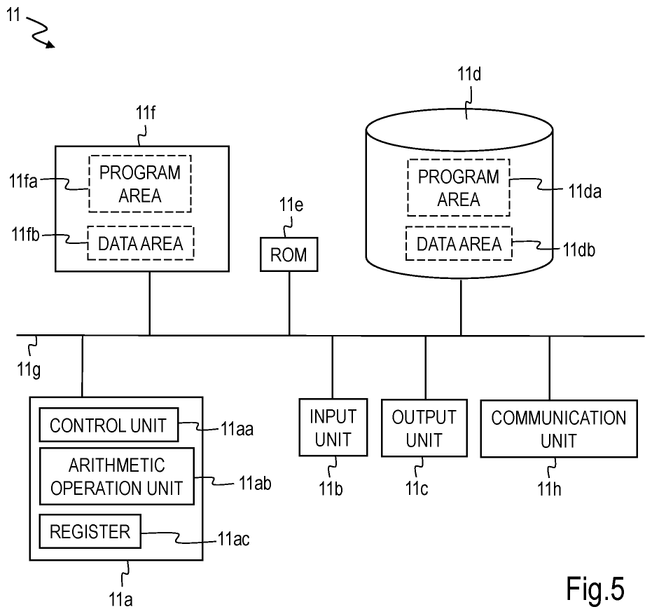

FIG. 5 is a block diagram illustrating a hardware configuration of the quantum compilation device 11 according to the embodiment. As illustrated as the example in FIG. 5, the quantum compilation device 11 in this example includes a central processing unit (CPU) 11a, an input unit 11b, an output unit 11c, a random access memory (RAM) 11d, a read only memory (ROM) 11e, an auxiliary storage device 11f, a communication unit 11h, and a bus 11g. The CPU 11a of this example includes a control unit 11aa, an arithmetic operation unit 11ab, and a register 11ac and executes various arithmetic processing in accordance with various programs read into the register 11ac. In addition, the input unit 11b is an input terminal, a keyboard, a mouse, a touch panel, or the like with which data is input. Also, the output unit 11c is an output terminal, a display, or the like with which data is output. The communication unit 11h is a LAN card or the like controlled by the CPU 11a that has read a predetermined program. In addition, the RAM 11d is a static random access memory (SRAM), a dynamic random access memory (DRAM), or the like, and incudes a program area 11da in which the predetermined program is stored and a data area 11db in which various pieces of data are stored. Also, the auxiliary storage device 11f is, for example, a hard disk, a magneto-optical disc (MO), or a semiconductor memory and includes a program area 11fa in which the predetermined program is stored and a data area 11fb in which various pieces of data are stored. In addition, the bus 11g connects the CPU 11a, the input unit 11b, the output unit 11c, the RAM 11d, the ROM 11e, the communication unit 11h, and the auxiliary storage device 11f such that information can be exchanged between these components. The CPU 11a writes the program stored in the program area 11fa of the auxiliary storage device 11f into the program area 11da of the RAM 11d in accordance with a read operating system (OS) program. Similarly, the CPU 11a writes the various pieces of data stored in the data area 11fb of the auxiliary storage device 11f into the data area 11db of the RAM 11d. In addition, addresses on the RAM 11d into which the program and the data have been written are stored in the register 11ac of the CPU 11a. The control unit 11aa of the CPU 11a sequentially reads the addresses stored in the register 11ac, reads the program and the data from the areas in the RAM 11d indicated by the read addresses, causes the arithmetic operation unit 11ab to sequentially execute arithmetic operations indicated by the program, and stores results of the arithmetic operations in the register 11ac. With such a configuration, the functional components of the quantum compilation device 11 are implemented.

The program described above can be recorded in a computer-readable recording medium. Examples of the computer-readable recording medium include a non-transitory recording medium. Examples of such a recording medium include a magnetic recording device, an optical disc, a magneto-optical recording medium, a semiconductor memory, and the like.

The program is distributed by selling, giving, or renting portable recording media such as DVDs or CD-ROMs recording the program thereon, for example. Furthermore, the program may also be distributed by being stored in a storage device of a server computer and being transferred from the server computer to other computers via a network. As described above, such a computer executing the program first temporarily stores the program recorded in the portable recording medium or the program transferred from the server computer in a storage device of the computer, for example. In addition, when executing processing, the computer reads the program stored in the storage device of the computer and executes processing in accordance with the read program. Also, in other modes of executing the program, the computer may read the program directly from the portable recording medium and execute processing in accordance with the program, or alternatively, the computer may sequentially execute processing in accordance with the received program every time the program is transferred from the server computer to the computer. The above processing may also be executed by a so-called application service provider (ASP) service that implements a processing function only by an execution instruction and acquisition of the result, without transferring the program from the server computer to the computer. Note that the program in this mode includes information used for processing by an electronic calculator and equivalent to the program (data or the like that is not a direct command to the computer but has a property for defining processing of the computer).

Although the present device is configured by executing a predetermined program in the computer in the embodiment, at least part of processing content may be implemented by hardware.

### Other Modification Examples

Note that the present invention is not limited to the above embodiment. For example, in the above-described embodiment, the quantum compilation device 10 obtains and outputs a set {U₁, . . . , U_{K}} capable of approximating the unitary matrix U with the approximation accuracy E=ε by the method described in Non Patent Literature 1. However, this does not limit the present invention, and the quantum compilation device 10 may obtain and output a set {U₁, . . . , U_{K}} that can approximate the unitary matrix U with the approximation accuracy E=ε by another method. For example, the quantum compilation device 10 may randomly obtain a set {U₁, . . . , U_{K}}, and the approximation accuracy E that can be realized by the set {U₁, . . . , U_{K}} may be set as ε.

Also, various types of processing described above may be executed not only in time series in accordance with the description but also in parallel or individually in accordance with processing capacity of the devices that execute the processing or as necessary. It is needless to say that appropriate modifications can be made without departing from the gist of the present invention.

### REFERENCE SIGNS LIST

1 Quantum compilation system
10, 11 Quantum compilation device
111, 112 Vector generation unit
113, 114 Matrix generation unit
115 Probability calculation unit
116 Output unit

1. A quantum compilation device comprising processing circuitry configured to:
obtain a probability p(k) that minimizes an error between
a distribution of first observed values obtained by observing, with any observation method, a first quantum state obtained by causing the quantum circuit to be compiled represented by a unitary matrix U to act on any input quantum state, and
a distribution of second observed values obtained by observing, with the observation method, a second quantum state obtained by causing a quantum circuit represented by each of a plurality of elements Uₖ∈{U₁, . . . , U_{K}} of a set {U₁, . . . , U_{K}} to act on the input quantum state with the probability p(k),
for the set {U₁, . . . , U_{K}} in which a unitary matrix representing elementary gates and/or a unitary matrix representing a product of unitary matrices each representing an elementary gate are the elements U₁, . . . , and U_{K}, and the unitary matrix U representing a quantum circuit to be compiled, where K is an integer of 2 or more, and k=1, . . . , and K; and
output an element Uₖ with the probability p(k).

2. The quantum compilation device according to claim 1, wherein
when the unitary matrix U is compiled by any one element U_{k′}∈{U₁, . . . , U_{K}} deterministically selected from the set {U₁, . . . , U_{K}}, the unitary matrix U can be approximated by the set {U₁, . . . , U_{K}} with an approximation accuracy E=ε, where k′∈{1, . . . , K}, and
when the unitary matrix U is compiled by the element Uₖ stochastically selected with the probability p(k) from the set {U₁, . . . , U_{K}}, the unitary matrix U can be approximated by the set {U₁, . . . , U_{K}} with an approximation accuracy E=ε² or can be approximated by approximately E=ε².

3. The quantum compilation device according to claim 1, wherein
the unitary matrix U is a 2^{N}×2^{N} matrix, and N is an integer of 1 or more,
{σ₁, . . . , σ_{J}} is an orthonormal basis of a 2^{2N}×2^{2N} Hermitian matrix, J=2^{4N}, and j=1, . . . , J,
e_{L}^{→} represents a 2^{N}-dimensional vertical vector, the L-th element from a head of the vertical vector e_{L}^{→} is 1, the other 2^{N}-1 elements are 0, and L=1, . . . , 2^{N},
$$\vec{U} = {\sum }_{L = 1}^{{2}^{N}} \vec{{e}_{L}} ⊗ ( U \vec{{e}_{L}} ) , \qquad [ Math . 22 ]$$
$$\vec{{U}_{k}} = {\sum }_{L = 1}^{{2}^{N}} \vec{{e}_{L}} ⊗ ( {U}_{k} \vec{{e}_{L}} ) , \qquad [ Math . 23 ]$$
$${α}_{1} ⊗ {α}_{2} \qquad [ Math . 24 ]$$
represents the Kronecker product of α₁ and α₂,
A represents a real matrix, a k-th column vector from a head of the real matrix A is ((Uₖ^{→})⁺σ₁Uₖ^{→}, (Uₖ^{→})⁺σ₂Uₖ^{→}, . . . , (Uₖ^{→})⁺σ_{J}Uₖ^{→})^{T}, β⁺represents an adjoint matrix of β, and γ^{T} represents transposition of γ,
b^{→} represents a real vector, and b^{→}=((U^{→})⁺σ₁U^{→}, (U^{→})⁺σ₂U^{→}, . . . , (U^{→})⁺σ_{J}U^{→})^{T},
Δ represents a set of real vectors, and Δ={(p(1), p(2), . . . , p(k))^{T}|Σₖ₌₁, . . . , ₖp(k)=1, p(k)≥0}, and
R represents a set of real vectors, and R={(tr[σ₁Φ], tr[σ₂Φ], . . . , tr[σ_{J}Φ])^{T}:^{∃}ρ≥0, (tr [ρ]=1)∧(0≤Φ≤ρ(×)I)}, tr[κ] represents a trace of κ, I represents a unit matrix of 2^{N}×2^{N}, ρ represents a positive semi-definite matrix of 2^{N}×2^{N}, γ≥0 and 0≤γ in the matrix γ represent that γ is a positive semi-definite matrix, that is, a Hermitian matrix of which an eigenvalue is non-negative, γ₁≤γ₂ in the matrices γ₁ and γ₂ of η×η represents that γ₂−γ₁≥0, that is, 65 ₂−γ₁ is a positive semi-definite matrix, η is an integer of 1 or more, μ is an integer of 1 or more, and Φ represents a positive semi-definite matrix, wherein
the quantum compilation device obtains p^{→}={p(1), . . . , p(k)}∈Δ that achieves the following expression.
$${min}_{\vec{p} ∈ Δ} {max}_{\vec{x} ∈ R} {\vec{x}}^{T} ( \vec{b} - A \vec{p} ) \qquad [ Math . 25 ]$$

4. A quantum compilation method performed by a quantum compilation device comprising:
obtaining a probability p(k) that minimizes an error between
a distribution of first observed values obtained by observing, with any observation method, a first quantum state obtained by causing the quantum circuit to be compiled represented by a unitary matrix U to act on any input quantum state, and
a distribution of second observed values obtained by observing, with the observation method, a second quantum state obtained by causing a quantum circuit represented by each of a plurality of elements Uₖ∈{U₁, . . . , U_{K}} of a set {U₁, . . . , U_{K}} to act on the input quantum state with the probability p(k),
for the set {U₁, . . . , U_{K}} in which a unitary matrix representing elementary gates and/or a unitary matrix representing a product of unitary matrices each representing an elementary gate are the elements U₁, . . . , and U_{K}, and the unitary matrix U representing a quantum circuit to be compiled
where K is an integer of 2 or more, and k=1, . . . , and K; and
an output step of outputting an element Uₖ with the probability p(k) in an output unit.

5. A non-transitory computer-readable recording medium storing a program for causing a computer to function as the quantum compilation device according to claim 1.
